(19) United States
(12) Patent Application Publication
(10) Pub. No.: US 2025/0046309 A1
(43) Pub. Date: Feb. 6, 2025

(54) CD PLAYER INTERACTION METHOD AND DEVICE BASED ON ARTIFICIAL INTELLIGENCE SPEECH CONTROL

(71) Applicant: Shenzhen Zhonglin Information Technology Co., Ltd., Shenzhen (CN)

(72) Inventor: Weibing HONG, Shenzhen (CN)

(73) Assignee: Shenzhen Zhonglin Information Technology Co., Ltd., Shenzhen (CN)

(21) Appl. No.: 18/920,361

(22) Filed: Oct. 18, 2024

(30) Foreign Application Priority Data
Jul. 4, 2024 (CN) 202410897976.7

(51) Int. Cl. G10L 15/22; G10L 25/51; G10L 25/78

(52) U.S. Cl. CPC G10L 15/22; G10L 25/51; G10L 25/78

(57) ABSTRACT

Disclosed are a CD player interaction method and device based on artificial intelligence speech control. The method comprises: performing preprocessing and feature extraction on a speech command by a VAD algorithm to obtain a feature vector parameter of the speech command; performing similarity matching by feature vectors of preset action commands of a CD player stored in a speech reference model library; and using an action command corresponding to a maximum similarity as a recognition result of the speech command, and transmitting the recognition result to the CD player to implement a corresponding function. Human-machine interaction of the CD player is realized.

### CROSS-REFERENCE TO RELATED APPLICATIONS

This application claims priority to Chinese Patent Application No. CN 202410897976.7, filed on Jul. 4, 2024. The content of the aforementioned application, including any intervening amendments thereto, is incorporated herein by reference.

### BACKGROUND

### 1. Technical Field

The disclosure relates to a compact disc (CD) player interaction method and device based on artificial intelligence speech control, and belongs to the technical field of players.

### 2. Description of Related Art

CD players are intelligent, high-fidelity, stereo audio devices controlled by microcomputers, adopt the advanced laser technology, digital technology and computer technology as well as various novel elements, have the advantages of high-density recording, long audio play time, ease in operation and quick program selection, and can vividly and rhythmically replay recorded contents to create a sense of immediacy.

Traditional CD players only have an audio playing function, need to be operated manually, are poor in human-machine interaction, do not have an IoT function and cannot be used cooperatively with smart home products, for example, they cannot be used as control devices of smart home products and cannot be controlled by speech recognition. Therefore, it is necessary to develop a technical solution of a multifunctional CD play based on artificial intelligence speech control.

### BRIEF SUMMARY OF THE INVENTION

In view of this, the disclosure provides a CD player interaction method and device based on artificial intelligence speech control to solve the problems that traditional CD players have only one function, are poor in human-machine interaction, cannot realize speech control and cannot be used cooperatively with smart home products.

To fulfil the above objective, the disclosure provides the following technical solution: a multifunctional CD player interaction method based on artificial intelligence speech control comprises the following steps:
acquiring a speech command from a user, and performing preprocessing and feature extraction on the speech command by means of a voice activity detection (VAD) algorithm to obtain a feature vector parameter of the speech command;
constructing a speech reference model library storing feature vectors of preset action commands of a CD player;
performing similarity matching on the feature vector parameter of the speech command and the feature vectors of the preset action commands of the CD player stored in the speech reference model library; and
using an action command corresponding to a feature vector with a maximum similarity as a recognition result of the speech command, and transmitting the obtained recognition result to a control chip of the CD player to control the CD player to implement a corresponding function.

As a preferred embodiment of the multifunctional CD player interaction method based on artificial intelligence speech control, the CD player and a specified smart home product are connected to a same router network by means of a wireless gateway; and the CD player uploads a control command to a remote server, and the remote server sends the control command to the specified smart home product.

As a preferred embodiment of the multifunctional CD player interaction method based on artificial intelligence speech control, a speech control command is uploaded to a remote server by means of a mobile terminal, and the remote server sends the speech control command to the CD player to implement a function of the CD player.

As a preferred embodiment of the multifunctional CD player interaction method based on artificial intelligence speech control, an acoustic signal is converted into an electric signal by means of a mobile terminal, the electric signal is uploaded to a remote server, the remote server sends the electric signal to the CD player, and the CD player amplifies the electric signal and outputs sounds.

The disclosure further provides a multifunctional CD player interaction device based on artificial intelligence speech control, adopting the multifunctional CD player interaction method based on artificial intelligence speech control and comprising an upper shell, wherein a lower shell is connected to a back side of the upper shell, a disc running space is formed on a front side of the upper shell, and a detachable cover is connected to an outer side of the disc running space;
a receiving space is formed in the upper shell and the lower shell, and a control assembly and a CD laser head are arranged in the receiving space; the control assembly comprises a control chip and a speech recognition module; the speed recognition module is in communication connection with the control chip by means of a circuit serial port and is used for recognizing a speech control command from a user to implement a function of a CD player; the CD laser head is electrically connected to the control chip, exposed to the disc running space and used for installing a CD;
a battery module is arranged in the receiving space, and the battery module is electrically connected to the control chip and used for supplying power to the CD player;
the control chip comprises a decoding chip, a storage chip and a wireless mesh gateway;
the storage chip is electrically connected to the decoding chip and used for storing data of the CD player; the wireless mesh gateway is in communication connection with the decoding chip by means of a circuit serial port and is used for connecting the CD player to a smart home product as a wireless gateway.

As a preferred embodiment of the multifunctional CD player interaction device based on artificial intelligence speech control, the multifunctional CD player interaction device based on artificial intelligence speech control further comprises an RGB (green, red, blue) atmosphere lamp, and the RGB atmosphere lamp is electrically connected to the control chip and used for indicating an operating mode of the CD player and functions as an audio atmosphere lamp of the CD player;

the multifunctional CD player interaction device based on artificial intelligence speech control further comprises an FM transmitting module, and the FM transmitting module is electrically connected to the control chip and used for FM audio receiving and broadcasting of the CD player.

As a preferred embodiment of the multifunctional CD player interaction device based on artificial intelligence speech control, the control chip further comprises a battery protection chip and a charge management chip;
the battery module is electrically connected to the battery protection chip, and the battery protection chip is electrically connected to the decoding chip and used for protecting the battery module;
the battery module is electrically connected to the charge management chip, and the charge management chip is electrically connected to the decoding chip and used for charge management of the battery module.

As a preferred embodiment of the multifunctional CD player interaction device based on artificial intelligence speech control, the control chip further comprises a core drive chip, the CD laser head is electrically connected to the core drive chip, and the core drive chip is electrically connected to the decoding chip and used for driving the CD laser head;
the control chip further comprises an audio power amplifier chip, and the audio power amplifier chip is electrically connected to the decoding chip and used for audio power amplification of the CD player.

As a preferred embodiment of the multifunctional CD player interaction device based on artificial intelligence speech control, the control chip further comprises an LCD drive chip, and the LCD drive chip is electrically connected to the decoding chip and used for drive control of a touch/LCD screen configured for the CD player;
the control chip further comprises an infrared remote control chip, and the infrared remote control chip is electrically connected to the decoding chip and used for controlling an infrared remote control unit configured for the CD player.

As a preferred embodiment of the multifunctional CD player interaction device based on artificial intelligence speech control, the multifunctional CD player interaction device based on artificial intelligence speech control further comprises a key module provided with physical keys exposed to a top of the upper shell, and the key module is electrically connected to the control chip and used for key control of the CD player;
the multifunctional CD player interaction device based on artificial intelligence speech control further comprises an interface module, and the interface module is electrically connected to the control chip and comprises an earphone interface, a USB flash disk interface, a SD card interface and a Type-C charge interface.

As a preferred embodiment of the multifunctional CD player interaction device based on artificial intelligence speech control, a desktop stand and a wall-mounted stand are arranged on a back side of the lower shell.

As a preferred embodiment of the multifunctional CD player interaction device based on artificial intelligence speech control, the multifunctional CD player interaction device based on artificial intelligence speech control further comprises a camera, and the camera is connected to the control chip by means of a Wi-Fi module and used for acquiring ambient environmental information of the CD player.

The disclosure has the following advantages: a speech command from a user is acquired, and preprocessing and feature extraction are performed on the speech command by means of a VAD algorithm to obtain a feature vector parameter of the speech command; a speech reference model library storing feature vectors of preset action commands of a CD player is constructed; similarity matching is performed on the feature vector parameter of the speech command and the feature vectors of the preset action commands of the CD player stored in the speech reference model library; and an action command corresponding to a feature vector with a maximum similarity is used as a recognition result of the speech command, and the obtained recognition result is transmitted to a control chip of the CD player to control the CD player to implement a corresponding function. In this way, human-machine interaction of the CD player can be realized by means of a speech command, and the CD player can be used cooperatively with a smart home product as a control device of the smart home product; and operation is convenient and fast.

### BRIEF DESCRIPTION OF THE DRAWINGS

To more clearly explain the technical solutions of the embodiments of the disclosure or the prior art, drawings used for describing the embodiments of the disclosure or the prior art are briefly introduced below. Obviously, the drawings in the following description are merely illustrative, and those skilled in the art can obtain other drawings according to the following ones without creative labor.

The structures, proportions and sizes mentioned here are merely used for explaining the contents disclosed to allow those skilled in the art to understand and read the contents, are not used for limiting the disclosure, and thus do not have any technical substantive meanings, and any modifications of the structures, changes of the proportions or adjustments of the sizes obtained without affecting the effects and purposes of the disclosure should also fall within the protection scope of the technical contents disclosed by the disclosure.

FIG. 1 is a flow diagram of a multifunctional CD player interaction method based on artificial intelligence speech control according to one embodiment of the disclosure;

FIG. 2 is a schematic diagram of a VAD algorithm adopted by the multifunctional CD player interaction method based on artificial intelligence speech control according to one embodiment of the disclosure;

FIG. 3 is a perspective structural view of a multifunctional CD player interaction device based on artificial intelligence speech control according to one embodiment of the disclosure;

FIG. 4 is an internal structural view of the multifunctional CD player interaction device based on artificial intelligence speech control according to one embodiment of the disclosure;

FIG. 5 is an exploded structural view of the multifunctional CD player interaction device based on artificial intelligence speech control according to one embodiment of the disclosure;

FIG. 6 is a schematic view of the hardware architecture of the multifunctional CD player interaction device based on artificial intelligence speech control according to one embodiment of the disclosure.
In the FIGS.: 1, upper shell; 2, lower shell; 3, disc running space; 4, detachable cover; 5, receiving space; 6, control assembly; 7, CD laser head; 8, control chip; 9, speech recognition module; 10, battery module; 11, decoding chip; 12, storage chip; 13, wireless mesh gateway; 14, RGB atmosphere lamp; 15, interface module; 16, FM transmitting module; 17, battery protection chip; 18, charge management chip; 19, core drive chip; 20, audio power amplifier chip; 21, LCD drive chip; 22, infrared remote control chip; 23, key module; 24, desktop stand; 25, wall-mounted stand; 26, camera.

### DETAILED DESCRIPTION OF PREFERRED EMBODIMENTS

The implementations of the disclosure are described below in conjunction with specific embodiments to allow those skilled in the art to easily understand other advantages and effects of the disclosure with reference to contents disclosed by the disclosure. Obviously, the embodiments described below are merely illustrative ones of the disclosure, and are not all possible ones of the disclosure. All other embodiments obtained by those ordinarily skilled in the art based on the following ones without creative labor should also fall within the protection scope of the disclosure.

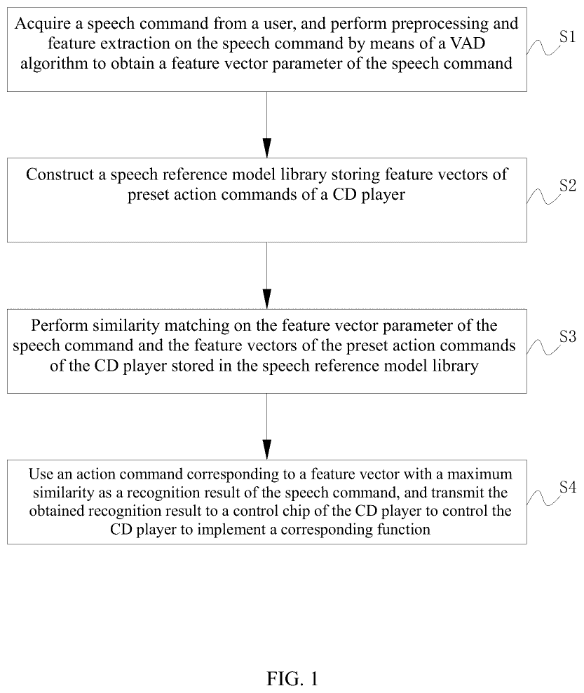

Referring to FIG. 1, one embodiment of the disclosure provides a multifunctional CD player interaction method based on artificial intelligence speech control, comprising the following steps:
S1: acquiring a speech command from a user, and performing preprocessing and feature extraction on the speech command by means of a VAD algorithm to obtain a feature vector parameter of the speech command;
S2: constructing a speech reference model library storing feature vectors of preset action commands of a CD player;
S3: performing similarity matching on the feature vector parameter of the speech command and the feature vectors of the preset action commands of the CD player stored in the speech reference model library; and
S4: using an action command corresponding to a feature vector with a maximum similarity as a recognition result of the speech command, and transmitting the obtained recognition result to a control chip of the CD player to control the CD player to implement a corresponding function.

In this embodiment, a speech command from a user is converted by a speech recognition module 9 into a control command corresponding to a CD player, and a corresponding function of the CD player is implemented by means of a control chip 8. Specifically, preprocessing and feature extraction are performed on an input speech to obtain a feature vector parameter of a speech command, similarity comparison is performed on the feature vector parameter of the speech command and feature vectors of preset action commands in a speech reference model library, an input feature vector with a maximum similarity is output as a recognition result, and other functions of the CD player are determined and controlled by means of the control chip 8.

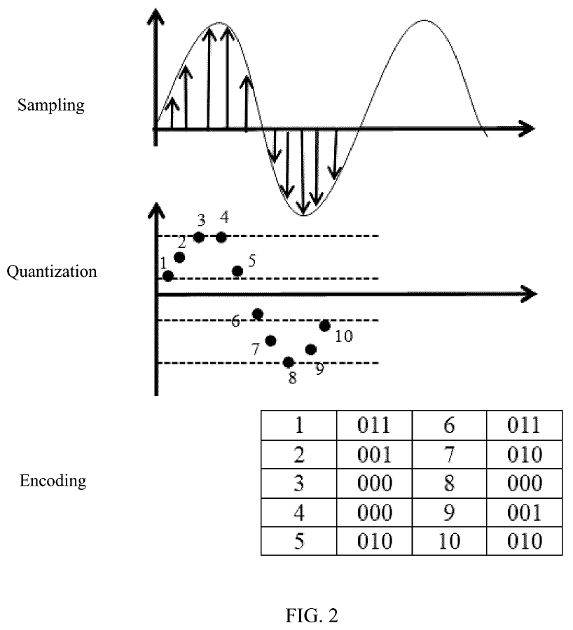

Referring to FIG. 2, wherein, a VAD algorithm can sample an original continuous analog signal and convert the original continuous analog signal into temporal discrete data to realized equal-interval sampling based on the basic principle that a large quantized interval is adopted for large signals and a small quantized interval is adopted for small signals, and at this moment, binary encoding of a digital signal is implemented. The speech reference model library comprises an acoustic model, a speech model and a dictionary, belongs to the prior art, and thus will not be detailed here.

In one possible embodiment, the CD player and a specified smart home product are connected to a same router network by means of a wireless gateway; and the CD player uploads a control command to a remote server, and the remote server sends the control command to the specified smart home product.

Specifically, a speech is converted by the speech recognition module 9 into a command corresponding to the CD player, the smart home product is controlled by means of the control chip 8, the CD player can be used as a wireless gateway, the CD player and other smart home products are arranged in the same router network, the CD player is controlled by means of the speech command, the CD player uploads the control command to the remote server, and the remote server sends the control command to other smart home products.

In one possible embodiment, a speech control command is uploaded to a remote server by means of a mobile terminal, and the remote server sends the speech control command to the CD player to implement a function of the CD player.

Specifically, the CD player can be remotely controlled by means of an APP on a mobile terminal such as a mobile phone to implement a function of the player. When the CD player is connected to the remote server, the APP on the mobile phone uploads a corresponding control command to the remote server, and the remote server sends a control command to the CD player to implement a function of the player.

In one possible embodiment, an acoustic signal is converted into an electric signal by means of a mobile terminal, the electric signal is uploaded to a remote server, the remote server sends the electric signal to the CD player, and the CD player amplifies the electric signal and outputs sounds.

Specifically, the effect of a microphone can be set by means of the APP on the mobile terminal such as the mobile phone, that is, when an acoustic signal is transmitted to a mobile phone, the acoustic signal can be quickly and completely played by the CD player. The mobile terminal converts the acoustic signal into an electric signal and uploads the electric signal to the remote server, the remote server sends the electric signal to the CD player, and the CD player amplifies the electric signal and outputs sounds by means of a speaker.

In one possible embodiment, data information of the CD player and the smart home product is directly saved in a remote server. When the CD player and other smart home products are connected to the remote server, all states and data of actions performed by the CD player and other smart home products will be directly stored in the remote server.

Wherein, by means of the APP on the mobile terminal such as the mobile phone, all data of the CD player and other smart home products can be checked via the remote server, that is, data of the CD player stored in the remote server can be directly acquired and checked by means of the APP on the mobile terminal such as the mobile phone.

In one possible embodiment, an alarm can be set by means of the CD player, the CD player can be controlled by a speech command to check the weather, and other functions such as interaction between speech commands and the CD player can be realized.

To sum up, according to the disclosure, a speech command from a user is acquired, and preprocessing and feature extraction are performed on the speech command by means of a VAD algorithm to obtain a feature vector parameter of the speech command; a speech reference model library storing feature vectors of preset action commands of a CD player is constructed; similarity matching is performed on the feature vector parameter of the speech command and the feature vectors of the preset action commands of the CD player stored in the speech reference model library; and an action command corresponding to a feature vector with a maximum similarity is used as a recognition result of the speech command, and the obtained recognition result is transmitted to a control chip of the CD player to control the CD player to implement a corresponding function. The CD player and the specified smart home product are connected to the same router network by means of the wireless gateway; a control command is uploaded to the remote server by means of the CD player, and the remote server sends the control command to the specified smart home product. A speech control command is uploaded to the remote server by means of a mobile terminal, the remote server sends the speech control command to the CD player to implement a function of the CD player. The mobile terminal converts an acoustic signal into an electric signal and uploads the electric signal to the remote server, the remote server sends the electric signal to the CD player, and the CD player amplifies the electric signal and outputs sounds. In this way, human-machine interaction of the CD player can be realized by means of a speech command, and the CD player can be used cooperatively with a smart home product as a control device of the smart home product; and operation is convenient and fast.

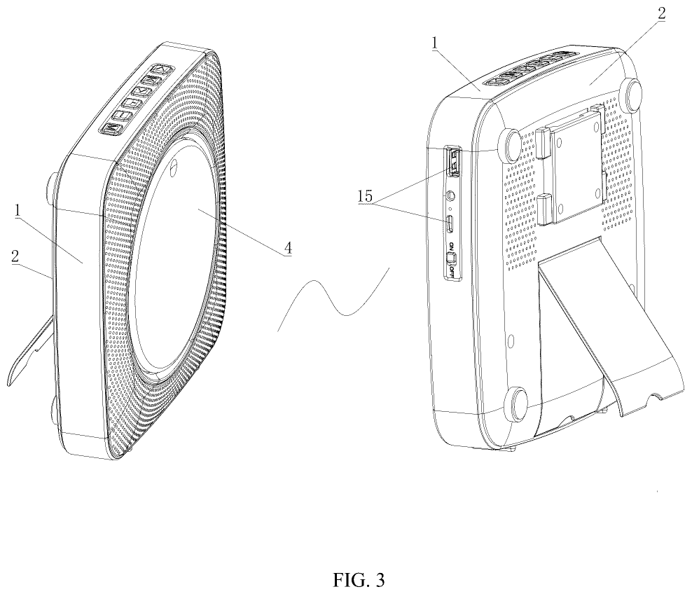

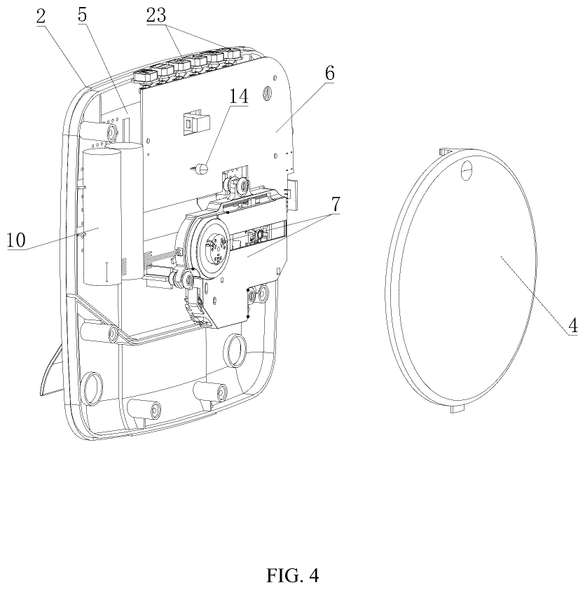

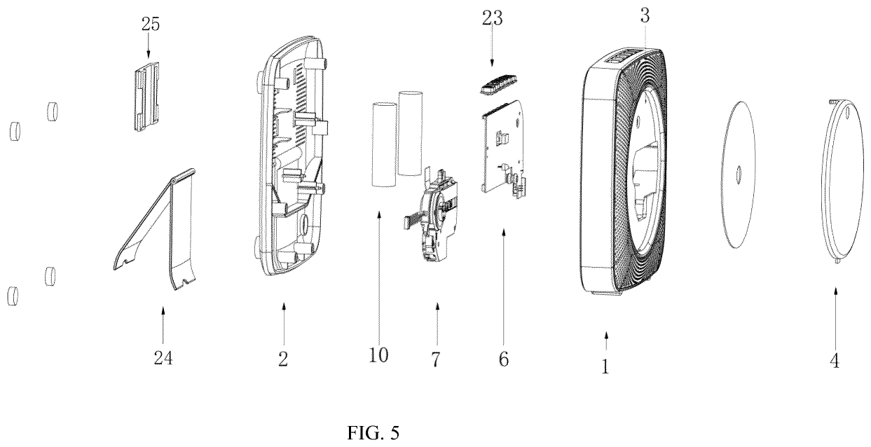

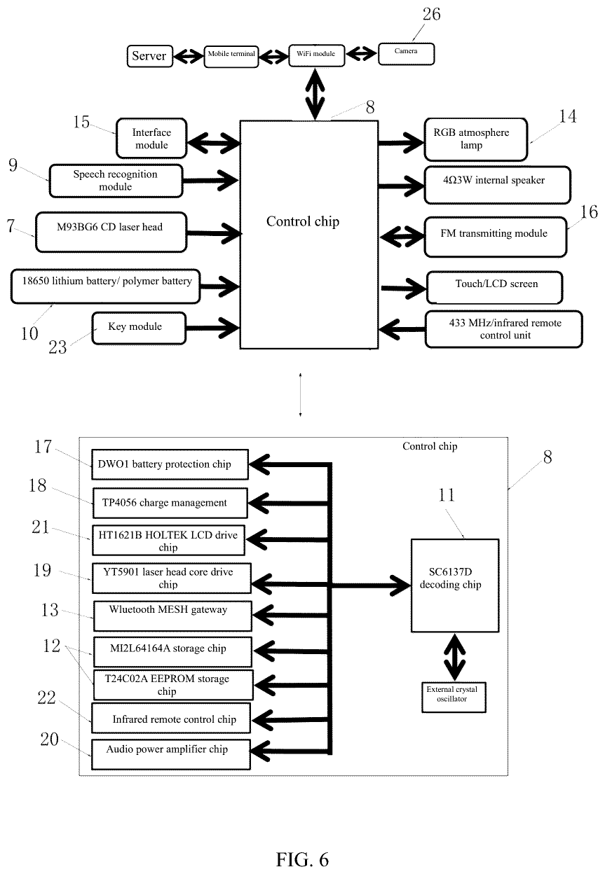

Referring to FIGS. 3, 4, 5 and 6, another embodiment of the disclosure provides a multifunctional CD player interaction device based on artificial intelligence speech control, which adopts the multifunctional CD player interaction method based on artificial intelligence speech control and comprises an upper shell 1, wherein a lower shell 2 is connected to a back side of the upper shell 1, a disc running space 3 is formed in a front side of the upper shell 1, and a detachable cover 4 is connected to an outer side of the disc running space 3;

wherein, a receiving space 5 is formed in the upper shell 1 and the lower shell 2, and a control assembly 6 and an M93BG6 CD laser head 7 are arranged in the receiving space 5; the control assembly 6 comprises a control chip 8 and a speech recognition module 9; the speed recognition module 9 is in communication connection with the control chip 8 by means of a circuit serial port and is used for recognizing a speech control command from a user to implement a function of a CD player; the CD laser head 7 is electrically connected to the control chip 8, exposed to the disc running space 3 and used for installing a CD;
wherein, a battery module 10 is arranged in the receiving space 5, and the battery module 10 is electrically connected to the control chip 8 and used for supplying power to the CD player;
wherein, the control chip 8 comprises a decoding chip 11, a storage chip 12 and a wireless mesh gateway 13; the storage chip 12 is electrically connected to the decoding chip 11 and used for storing data of the CD player; the wireless mesh gateway 13 is in communication connection with the decoding chip 11 by means of a circuit serial port and is used for connecting the CD player to a smart home product as a wireless gateway.

In this embodiment, the decoding chip 11 is an SC6137D chip and can be used as the control chip 8 of the whole CD player; and the storage chip 12 is an M12L64164A chip or a T24C02A chip and stores data of the CD player.

In one possible embodiment, the multifunctional CD player interaction device based on artificial intelligence speech control further comprises an RGB atmosphere lamp 14, wherein the RGB atmosphere lamp 14 is electrically connected to the control chip 8 and used for indicating an operating mode of the CD player and functions as an audio atmosphere lamp of the CD player; and the detachable cover 4 is made from a transparent material, and atmospheric light emitted by the RGB atmosphere lamp 14 is reflected out by the detachable cover 4. The brightness and frequency of the atmosphere lamp change with a change of the loudness of sounds played by the CD player; when different operating modes of the CD player are selected, the atmosphere lamp can function as a mode indicator light to indicate different operating modes by means of different states.

In one possible embodiment, the multifunctional CD player interaction device based on artificial intelligence speech control further comprises an FM transmitting module 16, wherein the FM transmitting module 16 is electrically connected to the control chip 8 and used for FM audio receiving and broadcasting of the CD player. An FM antenna is arranged in the CD player to realize FM audio receiving and broadcasting and channel search between 76 MHZ and 108 MHZ.

In one possible embodiment, the control chip 8 further comprises a DWO1 battery protection chip 17 and a TP4056 charge management chip 18, wherein the battery module 10 is electrically controlled to the battery protection chip 17, and the battery protection chip 17 is electrically connected to the decoding chip 11; the battery protection chip 17 is used for protecting the battery module 10; the battery module 10 is electrically connected to the charge management chip 18, and the charge management chip 18 is electrically connected to the decoding chip 11; and the charge management chip 18 is used for charge management of the battery module 10.

Specifically, the battery module 10 is provided with an 18650 lithium battery or a polymer battery and used for supplying power to the CD player. Wherein, the battery protection chip 17 is implemented by means of an integrated circuit design, and a protection mechanism adopted by the battery protection chip 17 mainly comprises overvoltage protection, undervoltage protection, overcurrent protection, short-circuit protection and the like. The overvoltage protection means that when a battery is charged, the protection chip will automatically cut off a charge power supply if the voltage exceeds a set voltage, to prevent the battery against overvoltage damage. The undervoltage protection means that when a battery discharges to a set voltage, the protection chip will cut off power supply of the battery by means of an external circuit to prevent a risk caused by a low battery level. The overcurrent protection means that when the current of a battery exceeds a set current, the protection chip will cut off power supply of the battery by means of an external circuit to prevent a risk caused by overcurrent of the battery. The short-circuit protection means that in case of a short circuit of a battery, the protection chip will cut off power supply of the battery by means of an external circuit to prevent a fire or other accidents. The circuit of the battery protection chip 17 belongs to the prior art and thus will not be detailed here.

Wherein, the charge management chip 18 is a chip integrated between the battery module 10 and a charger and can realize charge control, protection and monitoring of the battery module 10. The charge management chip 18 is used for controlling and regulating the charge current and voltage to ensure that a battery can be charged safely and efficiently. When the charger is connected to the device, the charge management chip 18 will automatically detect the battery level and state of charge of the battery, then determine an optimal charge mode according to the type of the battery and the properties of the charger, and automatically control the charge current and voltage to change to prevent the battery from being over-charged or over-discharged. In the charging process, the charge management chip 18 will monitor the temperature, voltage, current and other parameters of the battery and stop charging instantly in case of an exception to protect the battery the battery against overcharge, overdischarge, overheat and other damage. The charge management module 18 can also monitor the battery in real time to accurately measure, record and analyze the state, battery level, voltage, current, temperature and other parameters of the battery to guarantee the safety and service life of the battery.

In one possible embodiment, the control chip 8 further comprises a core drive chip 19, the CD laser head 7 is electrically connected to the core drive chip 19, and the core drive chip 19 is electrically connected to the decoding chip 11 and used for driving the CD laser head 7. The core drive chip 19 is a YT5901 chip and is used for driving the CD laser head 7.

In one possible embodiment, the control chip 8 further comprises an audio power amplifier chip 20, wherein the audio power amplifier chip 20 is electrically connected to the decoding chip 11 and used for audio power amplification of the CD player. The audio power amplifier chip 20 operates based on an analog circuit and a digital circuit and basically comprises an input stage, an intermediate stage and an output stage. Wherein, the input stage is used for receiving a low-level audio signal from an audio source, the intermediate stage is used for further amplifying the input signal, the output stage is used for driving a speaker to emit sounds by means of the amplified signal. In this way, an electric signal in the CD player is amplified to improve the sound volume, such that the CD player can play higher-quality audio.

In one possible embodiment, the control chip 8 further comprises an HT1621B LCD drive chip 21, wherein the LCD drive chip 21 is electrically connected to the decoding chip 11 and used for drive control of a touch/LCD screen configured for the CD player. The LCD drive chip 21 is controls an electric field of a liquid crystal material to change light transmission or reflection to realize image display.

In one possible embodiment, the control chip 8 further comprises an infrared remote control chip 22, wherein the infrared remote control chip 22 is electrically connected to the decoding chip 11 and used for controlling an infrared remote control unit configured for the CD player. The CD player is remotely controlled by means of the infrared remote control unit of the infrared remote control chip 22, and the infrared remote control unit may be a 433 MHz wireless transmission module or an infrared transmission module.

In one possible embodiment, the multifunctional CD player interaction device based on artificial intelligence speech control further comprises a key module 23 provided with physical keys exposed to the top of the upper shell 1, wherein the key module 23 is electrically connected to the control chip 8 and used for key control of the CD player.

In one possible embodiment, the multifunctional CD player interaction device based on artificial intelligence speech control further comprises an interface module 15, wherein the interface module 15 is electrically connected to the control chip 8 and comprises an earphone interface, a USB flash disk interface, a SD card interface and a Type-C charge interface. The Type-C charge interface can directly supply power to the CD player while charging the CD player and can also display the battery level in real time. By means of the USB flash disk interface and the SD card interface, the CD player play contents in a USB flash disk/SD card by a speaker and can realize FM audio receiving and broadcasting, and signals are transmitted by the audio power amplifier chip 20 to the earphone interface to be converted into sound waves.

In one possible embodiment, a desktop stand and a wall-mounted stand are arranged on a back side of the lower shell 2. The CD player can be placed on the top of a desk by means of the desktop stand and can be hung on a wall by means of the wall-mounted stand.

In one possible embodiment, the multifunctional CD player interaction device based on artificial intelligence speech control further comprises a camera 26, wherein the camera 26 is connected to the control chip 8 by means of a Wi-Fi module and used for acquiring ambient environmental information of the CD player.

Specifically, by means of the camera 26, the environment around the CD player can be observed directly, and image data are stored in an SD card and uploaded to a cloud server, and the environment around the CD player can be checked in real time by means of an APP on a mobile terminal.

The disclosure is specifically described in detail above with reference to general explanations and specific embodiments. It should be understood that some common adjustments or further innovations can be made to these specific embodiments based on the technical concept of the disclosure, and all these common adjustments or further innovations made without departing from the technical concept of the disclosure should also fall within the protection scope of the claims of the disclosure.

What is claimed is:

1. A multifunctional compact disc (CD) player interaction method based on artificial intelligence speech control, comprising the following steps:
acquiring a speech command from a user, and performing preprocessing and feature extraction on the speech command by means of a voice activity detection (VAD) algorithm to obtain a feature vector parameter of the speech command;
constructing a speech reference model library storing feature vectors of preset action commands of a CD player;
performing similarity matching on the feature vector parameter of the speech command and the feature vectors of the preset action commands of the CD player stored in the speech reference model library; and
using an action command corresponding to a feature vector with a maximum similarity as a recognition result of the speech command, and transmitting the obtained recognition result to a control chip of the CD player to control the CD player to implement a corresponding function.

2. The multifunctional CD player interaction method based on artificial intelligence speech control according to claim 1, wherein the CD player and a specified smart home product are connected to a same router network by means of a wireless gateway; and the CD player uploads a control command to a remote server, and the remote server sends the control command to the specified smart home product.

3. The multifunctional CD player interaction method based on artificial intelligence speech control according to claim 1, wherein a speech control command is uploaded to a remote server by means of a mobile terminal, and the remote server sends the speech control command to the CD player to implement a function of the CD player.

4. The multifunctional CD player interaction method based on artificial intelligence speech control according to claim 1, wherein an acoustic signal is converted into an electric signal by means of a mobile terminal, the electric signal is uploaded to a remote server, the remote server sends the electric signal to the CD player, and the CD player amplifies the electric signal and outputs sounds.

5. A multifunctional CD player interaction device based on artificial intelligence speech control, adopting the multifunctional CD player interaction method based on artificial intelligence speech control according to claim 1 and comprising an upper shell (1), wherein a lower shell (2) is connected to a back side of the upper shell (1), a disc running space (3) is formed on a front side of the upper shell (1), and a detachable cover (4) is connected to an outer side of the disc running space (3);
a receiving space (5) is formed in the upper shell (1) and the lower shell (2), and a control assembly (6) and a CD laser head (7) are arranged in the receiving space (5); the control assembly (6) comprises a control chip (8) and a speech recognition module (9); the speed recognition module (9) is in communication connection with the control chip (8) by means of a circuit serial port and is used for recognizing a speech control command from a user to implement a function of a CD player; the CD laser head (7) is electrically connected to the control chip (8), exposed to the disc running space (3) and used for installing a CD;
a battery module (10) is arranged in the receiving space (5), and the battery module (10) is electrically connected to the control chip (8) and used for supplying power to the CD player;
the control chip (8) comprises a decoding chip (11), a storage chip (12) and a wireless mesh gateway (13);
the storage chip (12) is electrically connected to the decoding chip (11) and used for storing data of the CD player; the wireless mesh gateway (13) is in communication connection with the decoding chip (11) by means of a circuit serial port and is used for connecting the CD player to a smart home product as a wireless gateway.

6. The multifunctional CD player interaction device based on artificial intelligence speech control according to claim 5, wherein the multifunctional CD player interaction device based on artificial intelligence speech control further comprises an RGB atmosphere lamp (14), and the RGB atmosphere lamp (14) is electrically connected to the control chip (8) and used for indicating an operating mode of the CD player and functions as an audio atmosphere lamp of the CD player;
the multifunctional CD player interaction device based on artificial intelligence speech control further comprises an FM transmitting module (16), and the FM transmitting module (16) is electrically connected to the control chip (8) and used for FM audio receiving and broadcasting of the CD player.

7. The multifunctional CD player interaction device based on artificial intelligence speech control according to claim 5, wherein the control chip (8) further comprises a battery protection chip (17) and a charge management chip (18);
the battery module (10) is electrically connected to the battery protection chip (17), and the battery protection chip (17) is electrically connected to the decoding chip (11) and used for protecting the battery module (10);
the battery module (10) is electrically connected to the charge management chip (18), and the charge management chip (18) is electrically connected to the decoding chip (11) and used for charge management of the battery module (10).

8. The multifunctional CD player interaction device based on artificial intelligence speech control according to claim 5, wherein the control chip (8) further comprises a core drive chip (19), the CD laser head (7) is electrically connected to the core drive chip (19), and the core drive chip (19) is electrically connected to the decoding chip (11) and used for driving the CD laser head (7);
the control chip (8) further comprises an audio power amplifier chip (20), and the audio power amplifier chip (20) is electrically connected to the decoding chip (11) and used for audio power amplification of the CD player.

9. The multifunctional CD player interaction device based on artificial intelligence speech control according to claim 5, wherein the control chip further comprises an LCD drive chip (21), and the LCD drive chip (21) is electrically connected to the decoding chip (11) and used for drive control of a touch/LCD screen configured for the CD player;
the control chip (8) further comprises an infrared remote control chip (22), and the infrared remote control chip (22) is electrically connected to the decoding chip (11) and used for controlling an infrared remote control unit configured for the CD player.

10. The multifunctional CD player interaction device based on artificial intelligence speech control according to claim 5, wherein the multifunctional CD player interaction device based on artificial intelligence speech control further comprises a key module (23) provided with physical keys exposed to a top of the upper shell (1), and the key module (23) is electrically connected to the control chip (8) and used for key control of the CD player;
the multifunctional CD player interaction device based on artificial intelligence speech control further comprises an interface module (15), and the interface module (15) is electrically connected to the control chip (8) and comprises an earphone interface, a USB flash disk interface, a SD card interface and a Type-C charge interface;
a desktop stand (24) and a wall-mounted stand (25) are arranged on a back side of the lower shell (2);
the multifunctional CD player interaction device based on artificial intelligence speech control further comprises a camera (26), and the camera (26) is connected to the control chip (8) by means of a Wi-Fi module and used for acquiring ambient environmental information of the CD player.
